(19) United States
(12) Patent Application Publication
(10) Pub. No.: US 2010/0034058 A1
(43) Pub. Date: Feb. 11, 2010

(54) ADDRESSING DISC STORAGE SPACE USING HEAD POSITION

(75) Inventor: Bart Van Rompaey, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,781

(22) PCT Filed: Nov. 25, 2005
(86) PCT No.: PCT/IB05/53912

§ 371 Date: Jun. 4, 2007

(30) Foreign Application Priority Data
Dec. 7, 2004 (EP) 04106348.8

(51) Int. Cl. G11B 21/08

(52) U.S. Cl. 369/30.12; G9B/21.012

(57) ABSTRACT

Current BD specification prescribes that in an ADIP an address is expressed with 21 bits, 19 to indicate the corresponding RUB number, and 2 to be set to 00, 01 and 10 consecutively in the 3 successive ADIP corresponding to one RUB, the smallest addressable portion of data on a disc. From this it derives that at most 32.2 GB of storage space can be addressed. Due to recent developments however, a storage capacity of 35 GB per layer could be achieved. According to the invention, one or more bits are added to the 21 bits currently allocated to express an address. This additional bits however are not stored in the ADIP but left implicit, exempting from a heavy deviation from the current BD encoding rules. The additional bits are reconstructed by an apparatus on the basis of the position on the information carrier where the corresponding RUB is present.

The present invention relates to a system comprising an information carrier and an apparatus for accessing the information carrier, to the information carrier and to the apparatus.

The current specifications for Blu-ray Disc rewritable (BD-RE) and write once (BD-R) describe a wobble in the pre-groove containing position information in the form of a bit sequence representing an address, the so-called Address In Pre-groove (ADIP). This is comparable to the CD specifications according to which there is an address called Absolute Time in Pre-groove (ATIP). These addresses are needed for allocation purposes on an empty or semi-empty disc.

One ADIP address, in BD-RE as well as in BD-R, consists of 24 bits, numbered AA23 down to AA0; the letters AA stand for physical ADIP Address. These bits are stored, together with 12 bits of auxiliary data, in the wobble of the pre-groove, and form an ADIP word. Three consecutive ADIP words in the pre-groove have the same physical length as one Recording Unit Block (RUB) in the main data channel, that is a block of information. A RUB is the smallest partition of data, namely 64K, that can be written on the disc.

Currently the following bit assignments have been made for the ADIP words:
AA23 . . . AA23: 3 bits to indicate the layer number;
AA22 . . . AA2: 19 bits, also called real RUB bits, to contain a sequential number, which number shall increase by one after each 3 consecutive ADIP words. (synchronized to the RUBs);
AA1,AA0: 2 bits, also called real ADIP bits, to be set to 00, 01 and 10 consecutively in the 3 successive ADIP words corresponding to one RUB. The setting 11 is reserved and shall not be used;
AX11 . . . AX0: 12 bits to contain auxiliary information about the disc: in the Inner Zone of the disc the auxiliary bits shall be used to store a copy of the disc information; elsewhere on the disc these 12 bits shall be set to zero.

The current specification for BD-RE and BD-R specifies capacities up to 27 GB. In future higher capacities can occur; for instance, capacities of 38 GB on a BD-RE disc are possible. For such higher capacities more recording addresses are required on a disc. As described above 19 bits are available according to the standard to indicate different recording addresses, and, with these 19 bits only, up to 32.2 GB of data can be addressed. For capacities higher than this not enough positions can be addressed on the disc. This is an important issue since for future multi-layer extensions of BD, 35 GB is thought of as target capacity per layer.

It is an object of the present invention to provide a system comprising an information carrier and apparatus for its access, the information carrier and the apparatus, by which a larger amount of data can be addressed on a record carrier, while at the same time involving as little as possible changes to the current encoding rules.

According to the invention this object is achieved by system as claimed in claim 1, an information carrier as claimed in claim 5 and an apparatus as claimed in 7.

According to the invention, the address label present in the blocks is indicative only of the local address, and the distinction between blocks having the same local address can be made on the basis of their position in the information carrier, which position is reflected in the estimated position of the head provided by the positioning control unit. This property allows for the addressing of an extended amount of data, because a number of bits that would be otherwise allocated to represent an address, i.e. an entire address fully indicative of the position within the physical space, can be allocated to represent a local address only, i.e. an address which is indicative of the position within a local area of the physical space, whereas the determination of the position within the physical space in its entirety is left to the apparatus.

In other words, while according to an existing format n bits are used to fully represent an address, according to the invention the same number of bits are used represent only a local address, whereby blocks with the same local address but nevertheless distinguishable by the apparatus can coexist in the same physical space, and thus the effect of extending the number of blocks that are addressable is achieved, without altering the encoding rules, or format, of the address label.

In a preferred embodiment, the local address is modularly increasing so as to form cycles of addresses, as claimed in claims 2 and 6. For example, the address may be incremented by one unit at each subsequent block, from zero to the maximum possible value, after which the value zero is used again, and so forth. In this way it is achieved that blocks with the same local address are located within the physical space at the maximum distance one from another.

The concept of an address of a block, as known from the prior art, indicative of the respective position of the block within the physical space in its entirety, can be re-introduced as global address, as claimed in claims 3 and 8.

In particular, the local address may represent a Least Significant Portion (LSP) of the global address, whereas an index identifying the cycle represents its Most Significant Portion (MSP), as claimed in claim 4; the MSP may consist even of a single bit, with the effect of doubling the addressable space.

Further advantageous embodiments are claimed in the other dependent claims.

These and other aspects of the system, information carrier and apparatus according to the invention will be further elucidated and described with reference to the drawings. In the drawings:

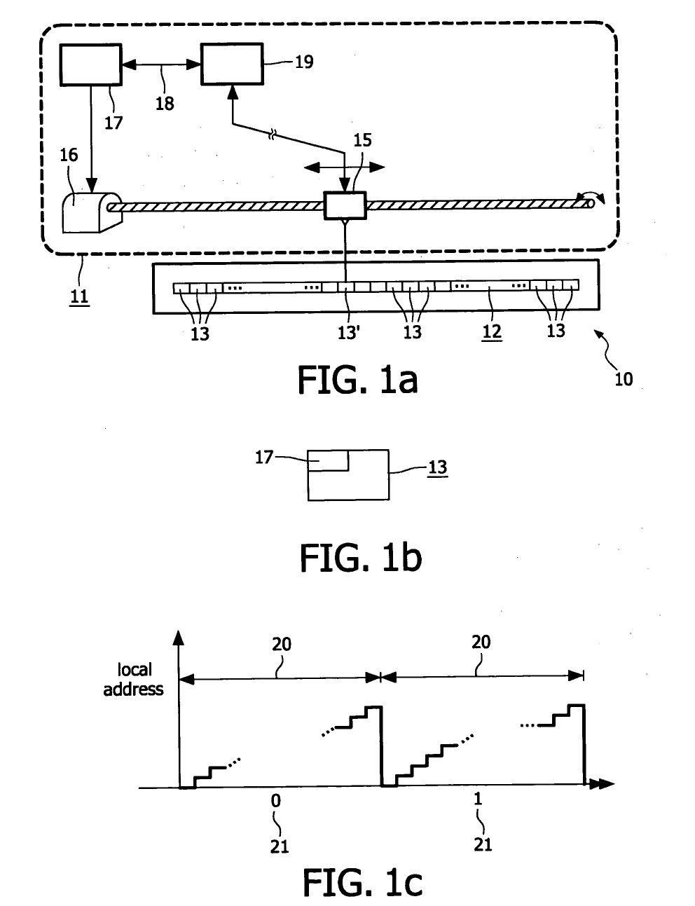

FIG. 1 a shows an embodiment of a system according to the invention,

FIG. 1b is an expanded view of a block of information shown also in FIG. 1a,

FIG. 1c shows the relation between position and local address with reference to the information carrier shown in FIG. 1a,

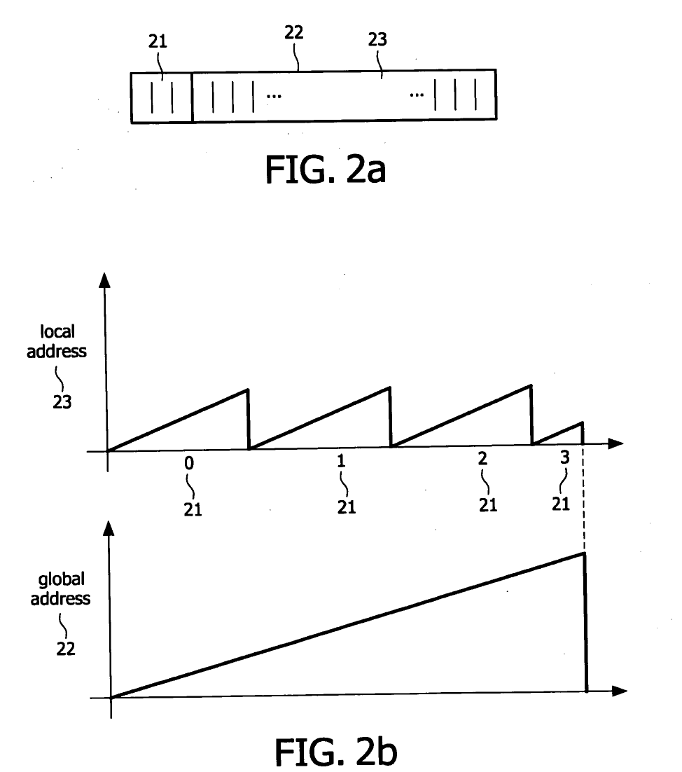

FIG. 2a shows the relation between local address and global address, and

FIG. 2b schematically depicts a global address.

FIG. 1a shows an embodiment of a system according to the invention, comprising an information carrier 10 and an apparatus 11 for its access.

The information carrier 10 has a physical space 12 and blocks 13 of information, also simply referred to as “blocks”, disposed at various positions within the physical space 12. In this example the information carrier 10 is an optical disc and the physical space 12 is a spiral track, however other embodiments are also possible: for example the physical space may have other forms and the information carrier could be also e.g. a magnetic disc, or a card with optical data. Each block 13 comprises an address label 14, as shown in an expanded view in FIG. 1b, which allows the identification of the each block 13. The apparatus 11 comprises a head 15 by means of which the blocks 13 can be accessed. In this example the head 15 is capable of generating a read signal based on optical properties of the information carrier along the spiral track and/or of altering the same optical properties upon a received write signal. In the FIG. the head 15 is shown at a distance from the information carrier 10, however in other embodiments the head 15 may be also in contact with the information carrier 10.

A positioning actuator 16 is capable of positioning the head 15 so as to be able to access the blocks 13 disposed at various locations, and in particular of retrieving the address labels 14. According to a usual implementation the positioning actuator 16 may comprise two distinct units, a first one for coarse positioning and a second one for fine positioning. The positioning actuator 16 is in its turn controlled by a positioning control unit 17. The precision and the resolution with which the positioning actuator 16 can be operated, make it impossible for the apparatus 11 to identify a priori what block 13 is being accessed, since two adjacent blocks 13 are disposed at a relatively small distance from each other: this is the fundamental reason why an address label 14 which allows the blocks 13 to be identified needs to be present. This is done by a block identification unit 19, present in the apparatus 11, which is connected to the head 15 and is capable of acquiring from a block 13 its address label 14, and to identify so the block 13.

In an information carrier according to the prior art the address label is indicative of an address, which address can be associated to a unique position in the physical space. The address label may consist of exactly the address, more commonly however, the address label consists of an encoded version of the address that also contains error code correction.

In contrast, in an information carrier 10 according to the invention the address label 14 is indicative of a local address only. The local address of a block 13 per se does not in general allow the identification of the block 13, because there might be several blocks 13 with the same local address, and therefore is different from the concept of address known from the prior art. However the knowledge of the local address may allow for the identification of the block 13 if combined with some approximate knowledge about the position of the block in the physical space. According to the invention this approximate knowledge is provided in the form of an estimated position 18 by the positioning control unit 17 to the block identification unit 19, which block identification unit 19 combines with said estimated position 18 the local address present in the address label 14 retrieved. In particular, the block identification unit 19 may identify the block being accessed as the closest block to the estimated position among the blocks having a local address like the one present in the address label 14 retrieved.

Various ways in which the positioning control unit 17 can provide the estimated position 18 can easily be envisaged.

It is known that an access to a block can take place sequentially or directly. During a sequential access, which is also called “tracking”, a plurality of blocks disposed sequentially is scanned while the head 15 is advanced: since addresses are generally incremented from a block to another, the address of a block is in principle known even before its address label is retrieved, since it must be equal to the address of the previous block incremented. During a direct access, the access of a specific block, said target block, and having a target address is sought, regardless of a current position of the head: the position control unit 17 calculates a movement based upon the target address and the current position, which in most situations can be assumed to be equal to the last retrieved address, and some parameters characteristic of the information carrier, namely parameters reflecting the density of data. The position control unit 17 then controls the positioning actuator 16 to perform the movement, or “jump”, according to the calculation, in the attempt to access the target block. However, due to the relatively low precision and the resolution of the positioning actuator 16 and of the inevitable approximations introduced in the calculation, it cannot be guaranteed that the head 15 will have been moved to the exact position from where the target block can be accessed. To check if the target block has been reached an access is performed, and the address of the block being accessed is determined and compared with the target address: if the two do not coincide, additional jumps are performed so as to reach the target block in successive approximations. Typically two iterations are required. In practice a block being accessed is necessarily in the neighborhood of the target block, even after the first jump.

This knowledge can be exploited to provide an estimated position 18 of the head 15, which can be calculated as:

the position the last block accessed, during a sequential access,

the position the target block, during a direct access.

In general terms it can be said that there is a direct relation between the estimated position and the commands given by the positioning control unit to the positioning actuator.

According to a preferred embodiment the local address is a number modularly increasing so as to form cycles. The consequent relation between the position in the physical space of the information carrier where a block 13 is located and its local address is exemplified in the graph of FIG. 1b. Each of the cycles 20 can be associated to a progressive cycle index 21. It can be observed that two blocks having the same local address are positioned well apart in the physical space 12 and can in general be easily distinguished.

Based on the cycle index 21 and on the local address, it is straightforward to associate to each individual block 13 a global address consisting of the cycle index 21 and the local address. In particular, as shown in FIG. 2a, the local address 23 and the cycle index 21 may coincide with the LSP and the MSP of a global address 22, respectively. The consequent relation between local address 23, cycle index 21 and global address 22 is exemplified in FIG. 2b.

The effect is that of virtually partitioning the storage space in pages, with one page per each value of the MSP.

In this circumstance is straightforward to derive a constraint on the number of bits allocated to represent the local address 23, and implicitly on the maximum number of cycles 20 that can be present in the information carrier 10, such that the a block 13 can still be identified upon its local address 23: with reference in particular to a direct access, which is the most critical situation, it can be said that the maximum distance between the global address of the target block and the global address of a block being accessed has to be less than half the maximum value of the LSP of the global address 22.

The global address 22 in the information carrier 10 according to the invention replaces the address in a known information carrier as an index uniquely identifying a block 13.

The global address 22 may exist merely as a reconstruction made by the apparatus 11 to distinguish different blocks 13, but not appear in the information carrier 10. However the global address 22 may be present also in the information carrier 10: for example when a reference, or pointer, to a block is recorded, this may have the form of an absolute global address 22.

In optical discs, particularly in recordable optical discs, such as CD-R(W), DVD-R(W), DVD+R(W), BD, etc., the address of a certain recording location, i.e. the location where a block of user-information can be recorded, needs to be pre-recorded in the recording location so as to be available even before any user-information is recorded therein. As it is known this is achieved by encoding the address, possibly along with other control information in the wobble, i.e. a transversal modulation of the track. The information carrier has therefore two channels, a main channel, or HF channel, related to the reflectivity along the track, and a secondary channel, or wobble channel, related to the transversal modulation of the track. The address present in the wobble channel is also replicated in the HF channel.

The physical features of the wobble modulation are variously constrained and allow only for the storage of a small amount of information, if compared to the information which can be stored in the HF channel in the same portion of track, so that in the wobble channel the address label represents all or most of the stored information, whereas in the HF channel it represents a small portion of the stored information, the biggest portion being the user information strictly speaking, e.g. music, video, software, etc.

Therefore it is difficult to add even a single bit of information to an existing number of bits allocated to represent an address without involving major changes to the entire system. According to the invention, the addressing space can be expanded by actually using the existing number of bits allocated to represent an address for the LSP of the expanded, or global, address, where the MSP is left implicit In the HF channel however, the entire global address may be present.

In the context of this invention, the term “blocks of information” may be referred to the ADIP frames present in the wobble channel, as well as to ECC blocks present in the HF channel. However, it could also be referred to the combination of the two, the ECC block and the three ADIP frames occupying the same segment of track. Advantageously, the global address may be stored in the ECC block whereas only the local address is stored in the ADIP frames.

The invention can be summarized as follows. Current BD specification prescribes that in an ADIP an address is expressed with 21 bits, 19 to indicate the corresponding RUB number, and 2 to be set to 00, 01 and 10 consecutively in the 3 successive ADIP corresponding to one RUB, the smallest addressable portion of data on a disc. From this it derives that at most 32.2 GB of storage space can be addressed. Due to recent developments however, a storage capacity of 35 GB per layer could be achieved.

According to the invention, one or more bits are added to the 21 bits currently allocated to express an address. This additional bits however are not stored in the ADIP but left implicit, exempting from a heavy deviation from the current BD encoding rules. The additional bits are reconstructed by an apparatus on the basis of the position on the information carrier where the corresponding RUB is present.

1. A system comprising an information carrier (10) and an apparatus (11) for accessing the information carrier, the information carrier (10) comprising a physical space (12) and blocks (13) of information disposed at respective positions within the physical space, each block (13) having associated therewith an address label (14) indicative only of a local address, the apparatus having:
a head (15) for retrieving the address label,
a positioning actuator (16) for positioning the head at a certain block (13′), so as to be able to retrieve the address label of the certain block,
a positioning control unit (17) for controlling the positioning actuator, capable of providing an estimated position (18) of the head, and
a block identification unit (19), connected to the head and to the positioning control unit, for determining the respective position of the certain block by combining the local address with the estimated position.

2. A system as claimed in claim 1, wherein the local address (23) is modularly increasing so as to form cycles (20) of addresses.

3. A system as claimed in claim 1, wherein the each block (13) is associated to a global address (22), indicative of its respective position within the physical space (12).

4. A system as claimed in claim 3, wherein the global address (22) is formed by a Least Significant Portion (LSP), being the local address (23), and a Most Significant Portion (MSP), being a cycle index (21) identifying the cycle (20) of addresses in which the each block (13) is present.

5. An information carrier (10) comprising a physical space (12) and blocks (13) of information disposed at respective positions within the physical space, each block having associated therewith an address label (14) indicative only of a local address (23).

6. An information carrier (5) as claimed in claim 5, the local address (23) being modularly increasing so as to form cycles of addresses.

7. An apparatus (11) for accessing an information carrier (10) comprising a physical space (12) and blocks (13) of information disposed at respective positions within the physical space, each block having associated therewith an address label (14) indicative only of a local address (23), comprising:
a head (15) for retrieving the address label,
a positioning actuator (16) for positioning the head at a certain block (13′), so as to be able to retrieve the address label of the certain block,
a positioning control unit (17) for controlling the positioning actuator, capable of providing an estimated position (18) of the head, and
a block identification unit (19), connected to the head and to the positioning control unit, for determining the respective position of the certain block by combining the local address with the estimated position.

8. An apparatus (11) as claimed in claim 7, capable of associating to the each block (13) a global address (22), which global address is indicative of the respective position of the each block within the physical space (12), and wherein the respective position of the certain block (13′) is determined by determining its global address.

9. An apparatus (11) as claimed in claim 8, wherein the global address (22) of the certain block (13′) is determined by determining which block (13) has a local address (23) like the local address retrieved is in the closest position to the estimated position (18).

10. An apparatus as claimed in claim 7, wherein the estimated position (18) is determined upon commands given by the positioning control unit (17) to the positioning actuator (16).
